(19) United States
(12) Patent Application Publication
(10) Pub. No.: US 2025/0353617 A1
(43) Pub. Date: Nov. 20, 2025

(54) DEVICE FOR THE MULTICHANNEL EVALUATION OF A SENSOR

(71) Applicant: Liebherr-Aerospace Lindenberg GmbH, Lindenberg (DE)

(72) Inventors: Frank KRONBURGER, Lindenberg (DE); Julian KINZELMANN, Hergensweiler (DE)

(21) Appl. No.: 19/198,923

(22) Filed: May 5, 2025

(30) Foreign Application Priority Data
May 15, 2024 (DE) 10 2024 113 611.1

(51) Int. Cl. B64F 5/60; G01D 18/00

(52) U.S. Cl. CPC B64F 5/60; G01D 18/00

(57) ABSTRACT

The disclosure proposes a device for the multichannel evaluation of a sensor, which comprises an output line for outputting a start signal for a sensor that can be coupled to the device, an input line for receiving a return signal output by the couplable sensor, a first control electronics module comprising an output channel for outputting the start signal and an input channel for receiving and evaluating the return signal output by the sensor, a second control electronics module comprising an output channel for outputting the start signal and an input channel for receiving and evaluating the return signal output by the sensor, a first isolation device, and a second isolation device, wherein the control electronics modules are designed to be redundant, and the input channel of the first control electronics module and the input channel of the second control electronics module are each connected to the input line.

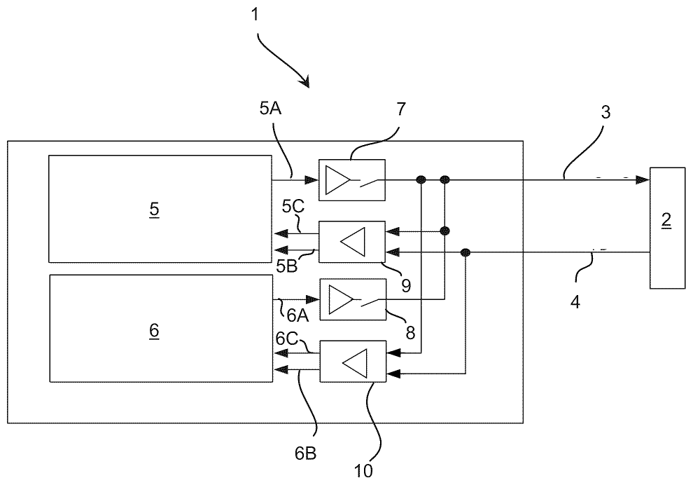

### CROSS REFERENCE TO RELATED APPLICATION

The present application claims priority to German Patent Application No. 10 2024 113 611.1 filed on May 15, 2024. The entire contents of the above-listed application are hereby incorporated by reference for all purposes.

### TECHNICAL FIELD

The present disclosure relates to a device for the multichannel evaluation of a sensor.

### BACKGROUND

The evaluation of sensors plays a key role, in particular in modern aviation technology, such as primary flight control systems of aircraft. These sensors are of major importance for, inter alia, accurately detecting a state of an aircraft and for precisely manipulating the control elements such as flaps, control surfaces and other critical components.

### SUMMARY

In this case, reliability for fault-free operation of a sensor or fault-free processing of the values detected by the sensor are of high importance in many fields of application. To achieve this, a plurality of redundant channels are provided for managing the signal electronics in order to operate an actuator or the like. This results in the requirement that the sensor information generated by the sensor has to be provided to each of the plurality of channels.

For example, U.S. Pat. No. 4,622,667 A provides a digital, fail-operational automatic flight control system having redundant, dissimilar data processing, in which a sensor unit has a separate data line for each of the two redundantly provided evaluation electronics modules. If, therefore, double redundancy is provided in relation to the evaluation or control electronics module of the sensor, the number of data lines from the sensor unit to the redundantly designed evaluation or control electronics module also doubles. For triple redundancy, the number of data lines and, in some circumstances, also the number of sensor systems required accordingly triples, such that the installation effort and complexity, the weight and the underlying costs also increase. This is caused by the above-mentioned direct correlation between the number of data lines interconnecting the sensor systems and the associated redundant evaluation or control electronics module and the desired redundancy.

The aim of the present disclosure is to overcome or lessen the above-mentioned drawbacks and problems from the prior art. This is achieved by a device as described herein.

According to the disclosure, a device for the multichannel evaluation of a sensor is provided, which comprises an output line for outputting a start signal for a sensor that can be coupled to the device, an input line for receiving a return signal output by the couplable sensor, a first control electronics module comprising an output channel for outputting the start signal and an input channel for receiving and evaluating the return signal output by the sensor, a second control electronics module comprising an output channel for outputting the start signal and an input channel for receiving and evaluating the return signal output by the sensor, a first isolation device, which is provided in a connection between the output channel of the first control electronics module and the output line and electrically isolates the output channel of the first control electronics module from the output line in an active state, and a second isolation device, which is provided in a connection between the output channel of the second control electronics module and the output line and electrically isolates the output channel of the second control electronics module from the output line in an active state, wherein the first control electronics module and the second control electronics module are designed to be redundant to one another, and the input channel of the first control electronics module and the input channel of the second control electronics module are each connected to the input line.

By means of the device according to the disclosure, the number of sensor systems required is reduced, although no compromises are made in relation to the redundancy of the control electronics module. This is done by providing a redundant design of the output line for driving a sensor that can be coupled to the device and redundant wiring from the input of the device to the two control electronics modules. To prevent more than one of the two control electronics modules driving the couplable sensor, a separate isolation device is provided for each of the two control electronics modules, which isolation device prevents, in an active state, a start signal of the associated control electronics module being sent to the output of the device or the output line of the device. Instead, the connection to the output or the output line and the corresponding control electronics module is disconnected or electrically isolated.

According to an optional development of the present disclosure, it can be provided that both the first control electronics module and the second control electronics module are each provided with a synchronisation input, which is connected to the output line in order to receive a start signal output on the output line.

For correct evaluation in a control electronics module, it can be advantageous for the exact point in time of the sensor being started, in response to which the sensor sends back a sensor value or a series of sensor values via the input channel of the device, to be known, since an evaluation algorithm is dependent on the correct synchronisation in relation to the start signal, for example. In order to then also make it possible to correctly evaluate the return signal sent by the sensor via the input channel when the isolation device associated with a control electronics module is supposed to be in the active state, i.e. electrically interrupts the output channel, it is necessary for the synchronisation input of each of the two control channels to be connected to the output channel of the device. In this way, the synchronisation of the start signal (irrespective of which of the two control electronics modules the start signal has output) is also identified when the output channel of a control electronics module is actually electrically isolated or disconnected from the output channel by the isolation device.

Advantageously, it can be provided here that each of the synchronisation inputs comprises a high-impedance input resistor in order not to distort a start signal of the output line, optionally wherein the high-impedance input resistor is implemented by an operational amplifier.

The high-impedance input resistor has the effect of there not being any influence on the state of the line to which the synchronisation input is connected. This allows other components, such as the other control electronics module, to control the line or drive the sensor without being impaired by the high-impedance component.

According to an advantageous modification to the present disclosure, it can be provided that each of the two input channels comprises a high-impedance input resistor in order not to distort a return signal of the sensor, optionally wherein the high-impedance input resistor is implemented by an operational amplifier.

According to another advantageous development of the present disclosure, it can be provided that the first isolation device and the second isolation device are each designed to be able to also assume, in addition to an active state, an inactive state, in which the relevant output channel is connected to the output line.

Optionally, it can be provided here that the first isolation device and the second isolation device are each implemented by a switch or an electrical component which can assume a tristate state.

A “tristate” state (also known as a high-Z state) refers to a particular property of an electronic component which is particularly advantageous in digital circuits such as integrated circuits and drivers. Normally, digital circuit outputs have two states: high (H) and/or low (L), wherein the tristate state is another possible output state in which the output is neither high nor low, but “high-impedance” (Z).

According to another advantageous modification to the present disclosure, it can be provided that the first isolation device and/or the second isolation device are each implemented by a switch and an operational amplifier, such that, even in an inactive state with a closed switch, the input resistor is designed to be high-impedance.

According to an optional development of the present disclosure, it can be provided that the first isolation device and the second isolation device are each designed to switch between an active state and an inactive state, wherein, in an inactive state, the output channel of the associated control electronics module is connected to the output line.

Furthermore, according to the present disclosure, it can be provided that a switching unit is provided which is designed to switch at least one of the two isolation devices into an active state, such that both isolation devices cannot be in the inactive state at the same time.

The switching unit is used to determine which of the two control electronics modules designed to be redundant to one another is in an active state, in which the output start signal is actually provided to the output line to operate the sensor. The start signal of the other control electronics module is also generated, but it is not relayed to the output line or the sensor owing to the active isolation device. If the switching unit determines a faulty state of the active control electronics module, it ensures that the control electronics modules are switched, such that the control electronics module considered to be fault-free takes over the actual starting of the sensor. To do this, the isolation device associated with the control electronics module considered to be faulty is shifted into an active state (electrical disconnection) and the control electronics module previously kept redundant is used for starting or driving a sensor (by deactivating the isolation device). This takes place by the associated isolation device being transferred into an inactive state in which a switch is made from an electrically isolating state into an electrically connecting state.

In this case, it can advantageously be provided that the switching unit is designed to monitor the first control electronics module and the second control electronics module for fault-free operation and, if a faulty state of the first control electronics module and/or the second control electronics module is detected, to electrically disconnect the faulty control electronics module(s), in particular the output channel thereof, from the sensor by activating the associated isolation device.

According to another advantageous modification to the present disclosure, it can be provided that the switching unit is designed to compare the signals output by the first control electronics module and the second control electronics module on their respective output channels. The switching unit can accordingly carry out a check of the different control electronics modules in order to assess whether or not one of the two control electronics modules is faulty. On the basis of this, the switching unit can carry out switching between the two control electronics modules designed to be redundant to one another, wherein, to do this, the respectively associated isolation devices are advantageously switched from an active state into an inactive state, or vice versa.

According to an optional modification to the present disclosure, it can be provided that only exactly one output line is provided for transmitting the start signal and/or only exactly one input line is provided for receiving the return signal from the sensor.

As a result, it is ensured that, for integrating the device with the plurality of control electronics modules designed to be redundant to one another, only one output line and one return line has to be provided between the device and the sensor to be coupled. This is also applicable if more than double redundancy of control electronics modules is provided, such that, in this case too, only one line is provided for transmitting the start signal to the sensor and one line is provided for returning the measured sensor value. Unlike in the prior art, it is not necessary here for a separate signal path to the sensor system or a separate sensor to have to be provided for each redundantly designed control electronics module.

The disclosure further relates to a system made up of a sensor and a device according to any of the previously discussed aspects, wherein a start signal received by the sensor via the output line results in the sensor outputting a measured sensor value via the input line.

The disclosure further relates to a system, wherein the system is part of a flight control system of an aircraft.

The disclosure further relates to an aircraft comprising a device according to any of the previously discussed aspects or comprising a system according to any of the previously discussed aspects.

### BRIEF DESCRIPTION OF THE FIGURE

Further features, details and advantages of the disclosure are clear from the following description of the figures, in which:

The Figure is a schematic view of a device according to the disclosure for the multichannel evaluation of a sensor.

### DETAILED DESCRIPTION

The Figure is a schematic view of the device 1 according to the disclosure. In this figure, the device 1 is connected to a sensor 2, which is designed to detect a certain sensor value and transmit it to the device 1.

For starting the sensor 2, the device 1 has an output line 3, via which the sensor 2 is informed that the device 1 wishes to receive the sensor value detected by the sensor 2. It is clear to a person skilled in the art that the start signal not only relates to a single sensor value, but can also comprise a series of a plurality of successive sensor values.

Once the sensor 2 has been accordingly started via the output line 3 of the device 1, the sensor 2 samples the corresponding sensor value and passes it to the device 1 via the input line 4.

In order to then provide redundancy of the control electronics module of the device 1, there is a first control electronics module 5 and a second control electronics module 6 that is redundant thereto. In this case, each of the two control electronics modules 5, 6 has an output channel 5A, 6A, each of which is designed to send the start signal to the sensor 2 via the output line 3.

Furthermore, each control electronics module 5, 6 also comprises an input channel 5B, 6B, which is used to receive the signals originating from the sensor on the input line 4. Each control electronics module 5, 6 is further designed to accordingly further process the received sensor value from the sensor 2.

In order to then prevent more than two lines, namely the output line 3 and the input line 4, needing to be provided between the device 1 and the sensor 2, a shutdown and isolation mechanism is provided in the device 1, which is implemented by means of a first isolation device 7 and a second isolation device 8. In this case, the first isolation device 7 is arranged between the output channel 5A of the first control electronics module 5 and the output line 3 of the device 1, whereas the second isolation device 8 is provided between the output channel 6A of the second control electronics module 6 and the output line 3 of the device 1.

Here, the isolation device 7, 8 can disconnect or close the connection of the input channel 5A, 6A to the output line 3 as desired. In a normal operating state of the device 1, one of the two isolation devices 7, 8 is activated, and therefore disconnects the electrical connection and closes the other of the two isolation devices 7, 8. It is thus ensured that only one of the two control electronics modules 5, 6 is connected to the output line 3 by its associated output channel 5A, 6A, such that the sensor 2 only receives one start signal. This accordingly rules out both control electronics modules 5, 6 simultaneously each sending a start signal to the output line 3, since at least one of the two isolation devices 7, 8 is active and accordingly interrupts a corresponding line connection.

This achieves the advantage that a single sensor is sufficient, although the control electronics modules are designed to be redundant to one another. Conventionally, it was proposed in the prior art that, to design the control electronics modules to be redundant, it was also necessary to design the sensor 2 to be redundant.

Reference signs 9, 10 denote input wiring of a relevant input channel 5B, 6B, which has high impedance, such that none of the feedback information sent from the sensor to the device 1 or to the relevant control electronics module 5, 6 can be distorted. For example, high-impedance input wiring can be implemented by an operational amplifier.

Furthermore, a synchronisation channel is identified, which feeds a start signal of the output line 3 back to each of the two control electronics modules 5, 6.

This makes it possible for the inactive control electronics module 5, 6, the isolation device 7, 8 of which is active and ensures that the output channel 5A, 6A is electrically disconnected from the output line 3, to receive a start signal of the active control electronics module 5, 6, in order to use this for synchronisation of a response from the sensor 2. It can also be provided here that the wiring for supplying the signal to the relevant control electronics module 5, 6 is high-impedance wiring, in order to prevent any potential distortion here, too.

A switching unit (not shown) is designed to control the two isolation devices 7, 8 such that it decides which of the two control electronics modules 5, 6 actually communicates with the sensor 2 via the output line 3. In this case, the switching unit can monitor the two control electronics modules 5, 6 in relation to a fault-free state and, if a faulty state is identified, can accordingly actuate the isolation devices 7, 8 in order to perform a switch of the control electronics module 5, 6 connected to the sensor via the output line 3.

The switching unit can further be capable of monitoring the output channel 5A, 6A of the inactive control electronics module 5, 6, of which the isolation device 7, 8 is active, and of performing a comparison with the signalling on the output line 3. If a deviation is ascertained in this process, inter alia, this can result in the active control electronics module being switched by the wiring of the respective isolation devices 7, 8 being modified.

Furthermore, it is clear to a person skilled in the art that the switching unit can also be checked as to whether one or both control electronics modules 5, 6 have failed, are operating normally or are operating in a faulty manner. The switching unit can be provided such that the second control electronics module 6 takes over if the first control electronics module 5 fails. This is performed by the associated isolation device 7 of the first control electronics module 5 being switched to be active, such that the connection to the output line 3 from the output channel 5A is interrupted. Furthermore, the isolation device 8 of the second control electronics module 6 is deactivated, such that the previous electrical disconnection is ceased and the active control electronics module 5, 6 has been switched. A device 1 schematically shown in the Figure is used in a flight control system, a remote electronics module or a signal electronics module of a drive system. In all of these fields, the electronics modules are subject to high availability requirements, and therefore it is advantageous to provide a plurality of control channels.

### LIST OF REFERENCE SIGNS

1 Device
2 Sensor
3 Output line
4 Input line
5 First control electronics module
5A Output channel of the first control electronics module
5B Input channel of the first control electronics module
5C Synchronisation channel of the first control electronics module
6 Second control electronics module
6A Output channel of the second control electronics module
6B Input channel of the second control electronics module
6C Synchronisation channel of the second control electronics module
7 First isolation device
8 Second isolation device
9 Operational amplifier for high-impedance input resistor of the first control electronics module
10 Operational amplifier for high-impedance input resistor of the second control electronics module

1. Device for multichannel evaluation of a sensor, comprising:
an output line for outputting a start signal for the sensor that can be coupled to the device,
an input line for receiving a return signal output by the sensor,
a first control electronics module comprising an output channel for outputting the start signal and an input channel for receiving and evaluating the return signal output by the sensor,
a second control electronics module comprising an output channel for outputting the start signal and an input channel for receiving and evaluating the return signal output by the sensor,
a first isolation device, which is provided in a connection between the output channel of the first control electronics module and the output line and electrically isolates the output channel of the first control electronics module from the output line in an active state, and
a second isolation device, which is provided in a connection between the output channel of the second control electronics module and the output line and electrically isolates the output channel of the second control electronics module from the output line in an active state, wherein
the first control electronics module and the second control electronics module are designed to be redundant to one another, and
the input channel of the first control electronics module and the input channel of the second control electronics module are each connected to the input line.

2. Device according to claim 1, wherein both the first control electronics module and the second control electronics module are each provided with a synchronisation input, which is connected to the output line in order to receive a start signal output on the output line.

3. Device according to claim 2, wherein each of the synchronisation inputs comprises a high-impedance input resistor in order not to distort a start signal of the output line.

4. Device according to claim 1, wherein each of the two input channels comprises a high-impedance input resistor in order not to distort a return signal of the sensor.

5. Device according to claim 2, wherein the first isolation device and the second isolation device are each designed to be able to also assume, in addition to the active state, an inactive state, in which a relevant output channel is connected to the output line.

6. Device according to claim 1, wherein the first isolation device and the second isolation device are each implemented by a switch or an electrical component which can assume a tristate state.

7. Device according to claim 1, wherein the first isolation device and/or the second isolation device are each implemented by a switch and an operational amplifier, such that, even in an inactive state with a closed switch, the input resistor is designed to be high-impedance.

8. Device according to claim 1, wherein the first isolation device and the second isolation device are each designed to switch between an active state and an inactive state, wherein, in an inactive state, the output channel of the associated control electronics module is connected to the output line.

9. Device according to claim 1, wherein a switching unit is provided which is designed to switch at least one of the two isolation devices into an active state, such that both isolation devices cannot be in the inactive state at the same time.

10. Device according to claim 9, wherein the switching unit is designed to monitor the first control electronics module and the second control electronics module for fault-free operation and, if a faulty state of the first control electronics module and/or the second control electronics module is detected, to electrically disconnect the faulty control electronics module(s), in particular the output channel thereof, from the sensor by activating the associated isolation device.

11. Device according to claim 9, wherein the switching unit is designed to compare the signals output by the first control electronics module and the second control electronics module on their respective output channels.

12. Device according to claim 1, wherein only exactly one output line is provided for transmitting the start signal and/or only exactly one input line is provided for receiving the return signal from the sensor.

13. System comprising the sensor and the device according to claim 1, wherein the system is configured such that a start signal received by the sensor via the output line results in the sensor outputting a measured sensor value via the input line.

14. System according to claim 13, wherein the system is part of a flight control system of an aircraft.

15. Aircraft comprising a device according to claim 1.

16. Device according to claim 3, wherein the high-impedance input resistor is implemented by an operational amplifier.

17. Device according to claim 4, wherein the high-impedance input resistor is implemented by an operational amplifier.
